(19) United States
(12) Patent Application Publication
(10) Pub. No.: US 2015/0151809 A1
(43) Pub. Date: Jun. 4, 2015

(54) BICYCLE HANDLEBAR ASSEMBLY

(71) Applicant: Mu-Rong Li, Taichung City (TW)

(72) Inventor: Mu-Rong Li, Taichung City (TW)

(21) Appl. No.: 14/096,024

(22) Filed: Dec. 4, 2013

(51) Int. Cl. B62K 21/12; B62K 21/18

(52) U.S. Cl. CPC B62K 21/12; B62K 21/18

(57) ABSTRACT

A bicycle handlebar assembly, which is adapted to be mounted on a steering tube of a bicycle, includes a handlebar and a stem. The handlebar has an assembling portion and two handle portions integrally extending from opposite ends of the assembling portion. The assembling portion has an arc groove defined in a side thereof. The arc groove of the assembling portion is configured to be assembled with one end of the stem 2. Under this arrangement, the arc groove of the assembling portion is provided for a rider to quickly and simply assemble the handlebar to the stem.

### BACKGROUND OF THE INVENTION

1. Field of the Invention

The present invention relates to a bicycle handlebar and more particularly to a bicycle handlebar with an assembling portion for quickly installation.

2. Description of Related Art

Bicycle handlebar is provided for a rider to control the riding direction. A conventional bicycle handlebar assembly includes a handlebar and a stem. The stem connects the handlebar to a steering tube of a bicycle. The stem has a stem body, a clamping member and a plurality of screws. The stem body has one end connected to the steering tube and a connection end corresponding to the clamping member. The clamping member is fixed to the connection end of the stem body via the screws so as to secure the handlebar to the stem body.

However, the conventional bicycle handlebar assembly has some disadvantages as following:

In operation, the handlebar should be secured on the stem by additional clamping member that is inconvenient for a rider to operate especially for a drop type handlebar which should be rotated to a suitable angle.

The present invention has arisen to mitigate and/or obviate the disadvantages of the conventional bicycle handlebar.

### SUMMARY OF THE INVENTION

The main objective of the present invention is to provide an improved bicycle handlebar.

To achieve the objective, a bicycle handlebar assembly, which is adapted to be mounted on a steering tube of a bicycle, comprises a handlebar and a stem. The handlebar has an assembling portion defined at a central part thereof and two handle portions extending integrally from opposite ends of the assembling portion. The assembling portion has an arc groove defined in a side thereof from top to bottom and a plurality of assembling holes defined therethrough. The assembling holes are spaced a distance apart in the top and the bottom of the assembling portion respectively. The stem has a connection end assembled in the arc groove of the assembling portion and the other end to be mounted on the steering tube of the bicycle. The connection end of the stem abuts against a bottom of the arc groove and is spaced apart from an upper wall and a lower wall of the arc groove respectively. The connection end of the stem has a plurality of threaded holes corresponding to the assembling holes of the assembling portion. A plurality of screw members pass through the assembling holes of the assembling portion and are screwed into the threaded holes of the stem so that the assembling portion of the handlebar is connected to the connection end of the stem.

Under this arrangement, the arc groove of the assembling portion is provided for a rider to quickly and simply assemble the handlebar to the stem.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a bicycle handlebar assembly in accordance with a preferred embodiment of the present invention;

FIG. 2 is an exploded perspective view of the bicycle handlebar assembly of FIG. 1;

FIG. 3 is another exploded perspective view of the bicycle handlebar assembly of FIG. 1 taken from another angle;

FIG. 4 is a cross-sectional view of the bicycle handlebar assembly along line IV-IV of FIG. 1;

FIG. 5 illustrates an assembling portion of a handlebar is slightly adjusted relative to a stem;

FIG. 6 illustrates the bicycle handlebar assembly of FIG. 1 is assembled on a steering tube; and

FIG. 7 illustrates a bicycle handlebar assembly in accordance with another embodiment of the present invention assembled on the steering tube.

### DETAILED DESCRIPTION OF THE INVENTION

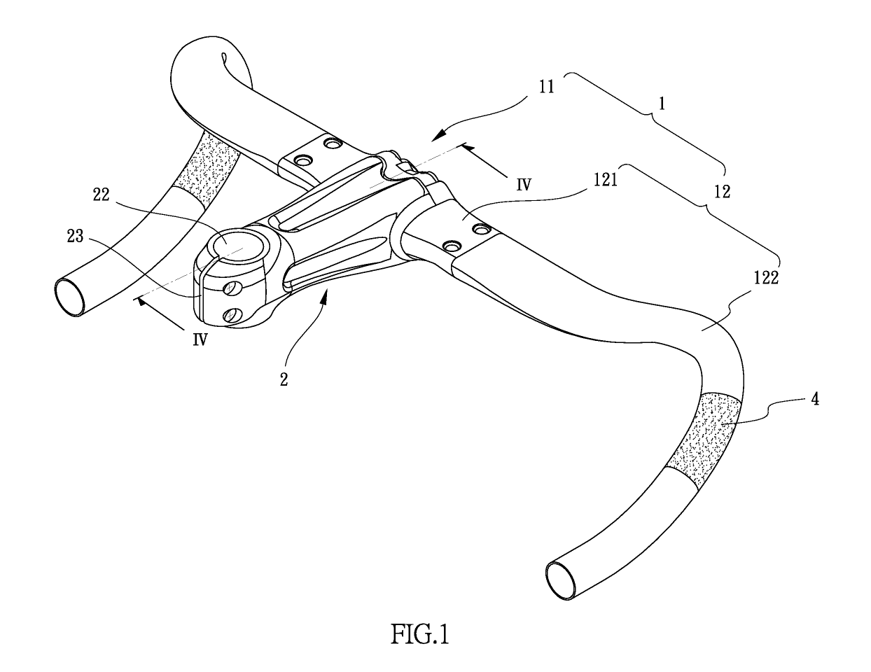

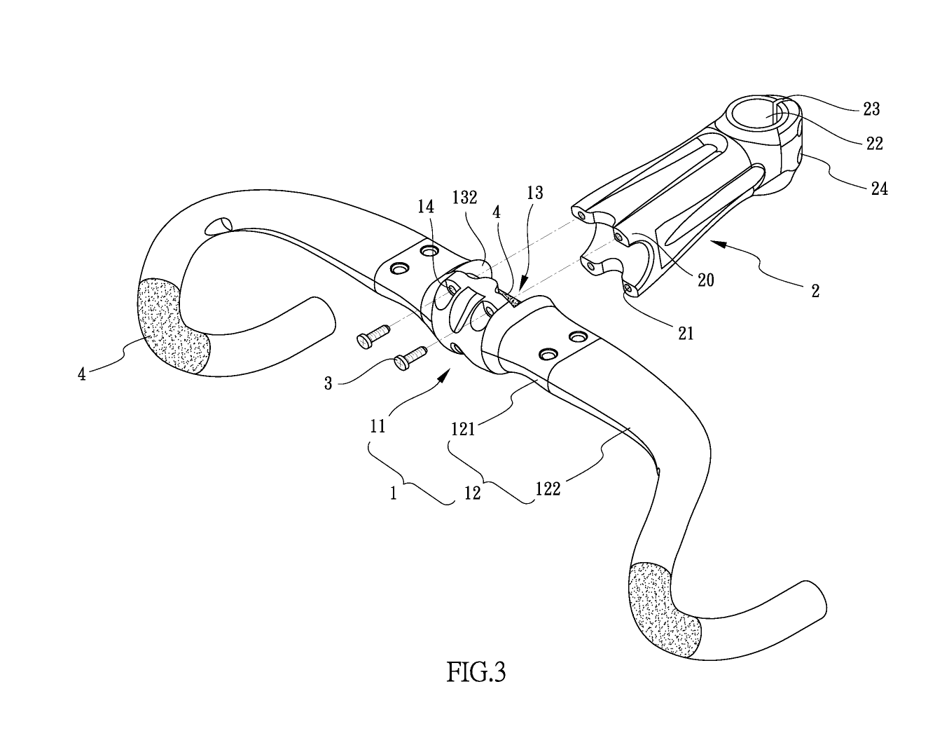

Referring to FIGS. 1-6, a bicycle handlebar assembly in accordance with a preferred embodiment of the present invention, which is adapted to be mounted on a steering tube 10 of a bicycle, comprises a handlebar 1 and a stem 2.

The handlebar 1 has an assembling portion 11 defined at a central part thereof and two handle portions 12 extends integrally from opposite ends of the assembling portion 11 of the handlebar 1. The assembling portion 11 of the handlebar 1 is substantially cylindrical in shape. The assembling portion 11 has an arc groove 13 defined in a side thereof. The arc groove 13 of the assembling portion 11 is opened from top to bottom. Furthermore, the assembling portion 11 has a plurality of assembling holes 14 defined therethrough. The assembling holes 14 are spaced a distance apart in the top and the bottom of the assembling portion 11 respectively.

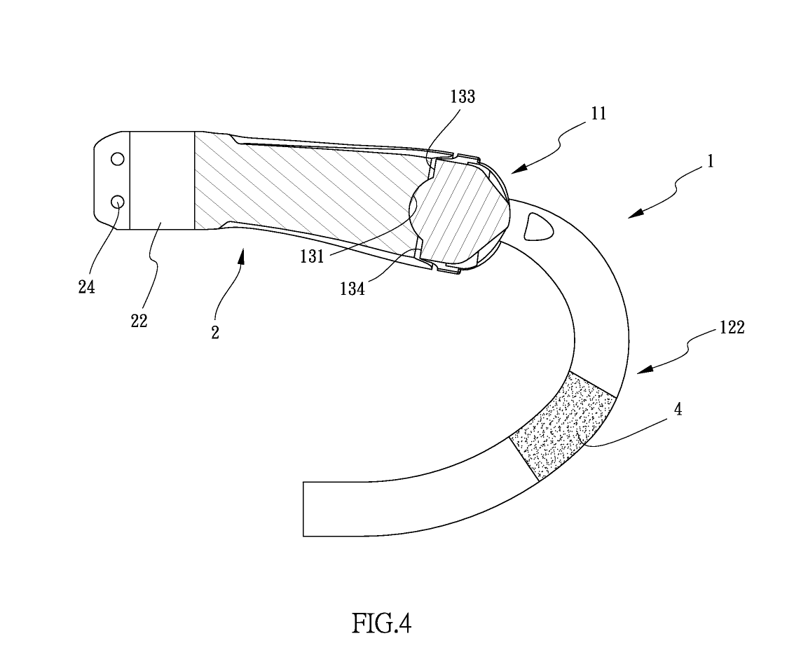

The stem 2 has a connection end 20 assembled in the arc groove 13 of the assembling portion 11, which abuts against a bottom of the arc groove 13, wherein the connection end 20 of the stem 2 is spaced apart from an upper wall 133 and a lower wall 134 of the arc groove 13, as shown in FIG. 4. The stem 2 is mounted on the steering tube 10 of the bicycle with one end opposite to the connection end 20. The stem 2 has a plurality of threaded holes 21 defined in the connection end 20 thereof which corresponds to the assembling holes 14 of the assembling portion 11. A plurality of screw members 3 pass through the assembling holes 14 of the assembling portion 11 and are screwed into the threaded holes 21 of the stem 2 so that the assembling portion 11 of the handlebar 1 is connected to the connection end 20 of the stem 2. Specifically, the connection potion 11 is integrated with the two handle portions 12 so as to achieve a lightweight design.

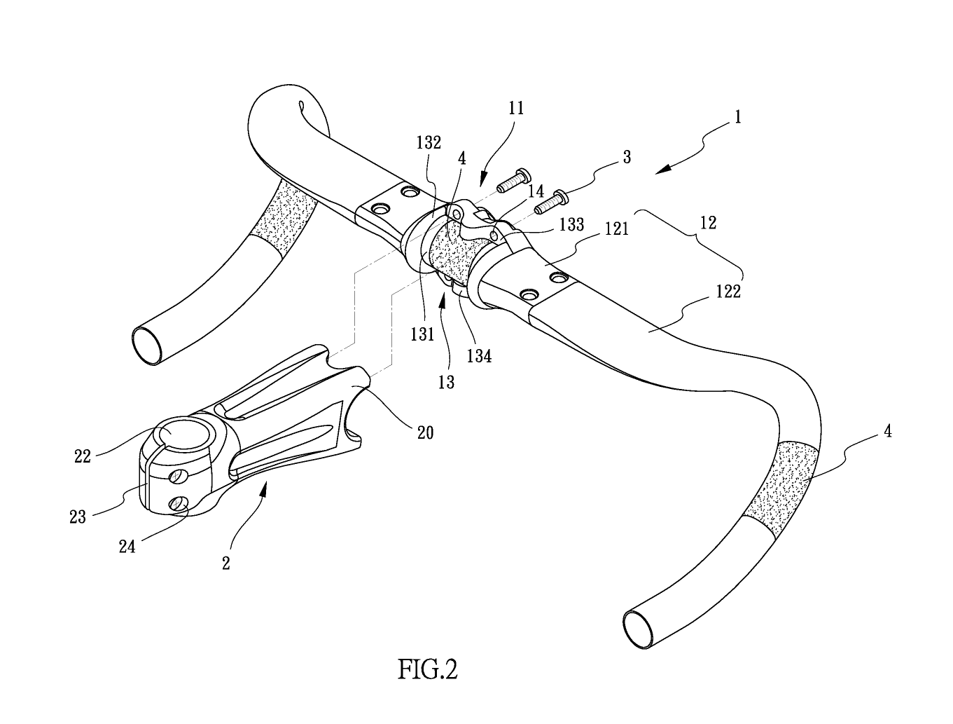

Referring to FIGS. 2-4, the assembling portion 11 of the handlebar 1 is configured to be assembled with the connection end 20 of the stem 2, which is provided for a rider to quickly and simply assemble the handlebar 1 to the stem 2. Specifically, the arc groove 13 of the assembling portion 11 has a bottom surface 131 and two lateral surfaces 132 at two sides. The upper wall 133 and the lower wall 134 of the arc groove 13 are convex in shape. The connection 20 end of the stem 2 is received in the arc groove 13 of the assembling portion 11 and abuts against the bottom surface 131 of the arc groove 13. The two lateral surfaces 132 of the arc groove 13 abut against opposite sides of the connection end 20 the stem 2. Under this arrangement, the arc groove 13 of the connection potion 11 is configured to accommodate with connection end 20 of the stem 2 so that the connection end 20 of the stem 2 could be positioned in the arc groove 13 of the assembling portion 11 directly; therefore, the rider has no need to adjust the handlebar 1 in a suitable angle especially for a dropped handlebar so as to save the assembling time.

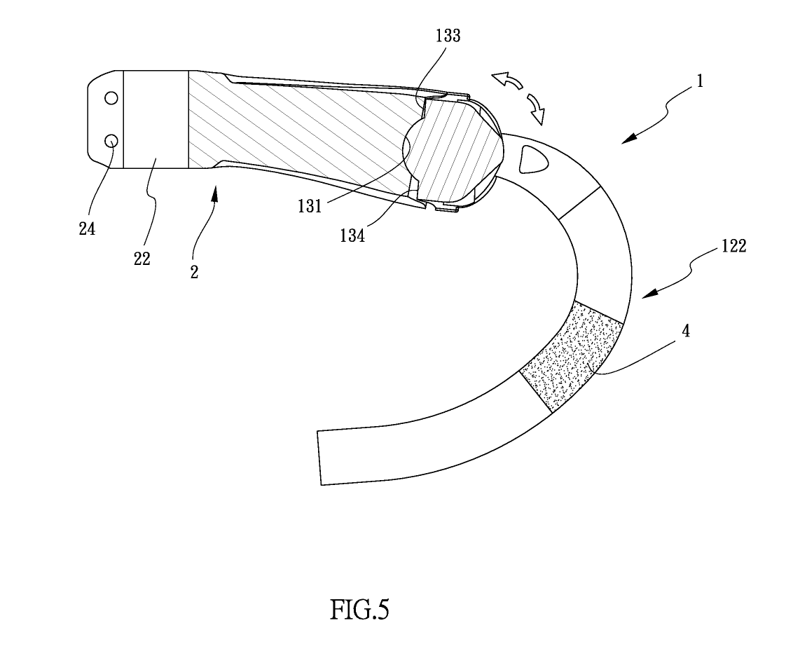

Furthermore, the connection end 20 of the stem 2 corresponding to the bottom surface 131 of the arc groove 13 is arc shaped, as shown in FIGS. 1-2. In the preferred embodiment, the handlebar 1 and stem 2 are made from carbon fibers provided for a lightweight. In addition, the bottom surface 131 of the arc groove 13 has a skidproof section 4 disposed thereon so as to avoid a slide as the stem 2 mounted in the arc groove 13 of the handle 1. Also, each of the two handle portion 12 has another skidproof section 4 disposed thereon for holding tightly, as shown in FIGS. 1-3. Referring to FIGS. 4-5, the connection end 20 of the stem 2 is spaced apart from the upper wall 133 and the lower wall 134 of the arc groove 13, so that the handlebar 1 could be slightly adjusted relative to the stem 2 for a suitable position.

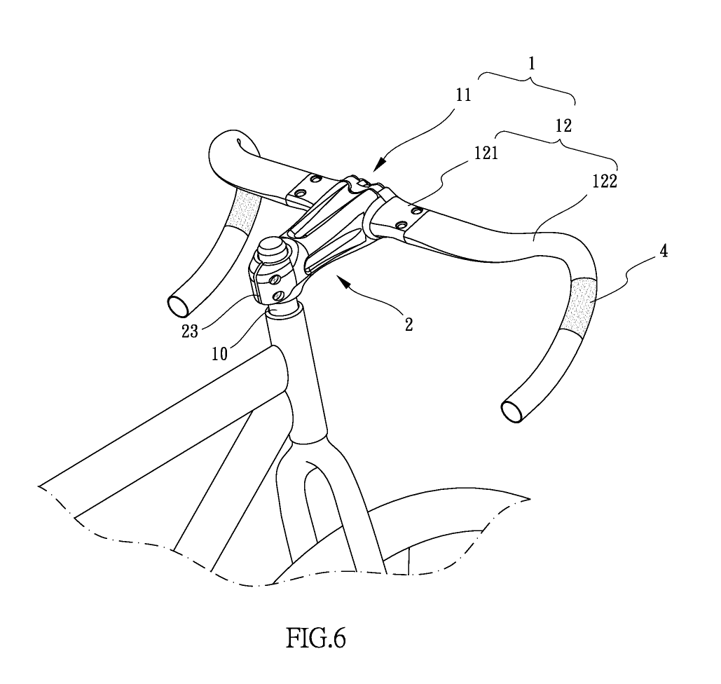

Referring to FIGS. 1-3, the stem 2 has a through hole 22 vertically defined at the end opposite to the connection end 20 of the stem 2. The stem 2 is mounted on the steering tube 10 of the bicycle via the through hole 22. Specifically, the stem 2 has a gap 23 vertically defined at the end opposite to the connection end 20 and in communication with the through hole 22 of the stem 2. The stem 2 further has a plurality of lock holes 24 transversely defined through one end of the stem 2 opposite to the connection end 20. Therefore, the gap 23 and the through hole 22 are shrunk by screws which are screwed into the lock holes 24 of the stem 2, so that the stem 1 is secured on the steering tube 10 of the bicycle, as shown in FIG. 6.

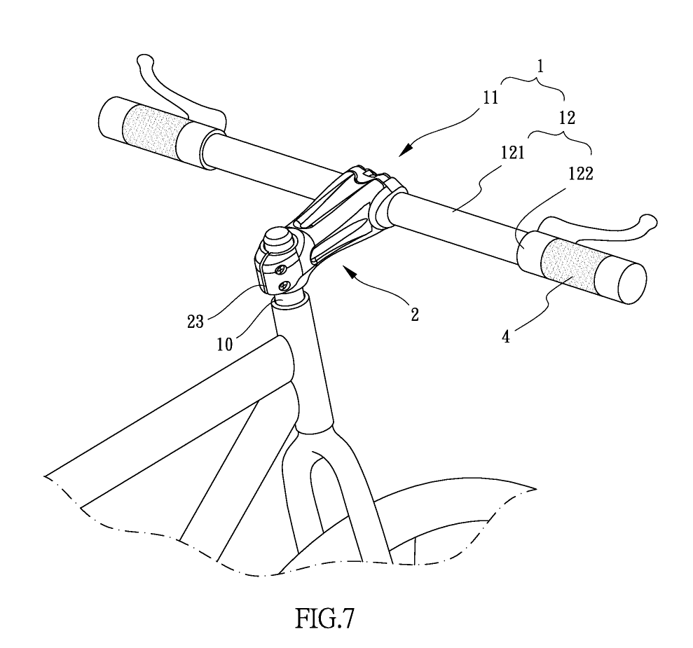

The connection potion 11 with arc groove 13 is integrated with the two handle portions 12, which could be applied in a variety of types of bicycle handlebars. In the preferred embodiment of the present invention, each of the two handle portion 12 includes a horizontal potion 121 and a gripping portion 122. The horizontal portion 121 is transversely extended from one of the connection portion 11 of the handlebar 1 and the gripping portion 122 is further extended from one end of the horizontal portion 121 opposite to the connection portion 11. The gripping portion 122 of the respective handle portion 12 has another skidproof section 4 disposed thereon. FIG. 6 shows a bicycle handlebar in accordance with the preferred embodiment, which is applied for a dropped handlebar with a curved gripping portion 122 of the handle portion 12. FIG. 7 shows another bicycle handlebar in accordance with another embodiment, which is applied for a flat handlebar with a straight gripping portion 122 of the handle portion 12. (Shapes of the handlebar 1 are not limited by the present invention.)

Although the invention has been explained in relation to its preferred embodiment, it is to be understood that many other possible modifications and variations can be made without departing from the scope of the invention as hereinafter claimed.

What is claimed is:

1. A bicycle handlebar assembly, which is adapted to be mounted on a steering tube of a bicycle, comprising:
a handlebar having an assembling portion defined at a central part thereof and two handle portions extending integrally from opposite ends of the assembling portion, the assembling portion having an arc groove defined in a side thereof from top to bottom, the assembling portion having a plurality of assembling holes defined therethrough, the assembling holes being spaced a distance apart from each other; and
a stem having a connection end assembled in the arc groove of the assembling portion and the other end to be mounted on the steering tube of the bicycle, the connection end of the stem abutting against a bottom of the arc groove and being spaced apart from an upper wall and a lower wall of the arc groove respectively, the connection end of the stem having a plurality of threaded holes corresponding to the assembling holes of the assembling portion; and
a plurality of screw members passing through the assembling holes of the assembling portion and screwed into the threaded holes of the stem so that the assembling portion of the handlebar is connected to the connection end of the stem.

2. The bicycle handlebar assembly as claimed in claim 1, wherein the arc groove of the assembling portion has a bottom surface and two lateral surfaces at two sides; the upper wall and the lower wall are convex in shape; the connection end of the stem is received in the arc groove of the assembling portion and abuts against the bottom surface of the arc groove; and the two lateral surfaces of the arc groove abut against opposite sides of the connection end of the stem.

3. The bicycle handlebar assembly as claimed in claim 2, wherein the bottom surface of the arc groove has a skidproof section disposed thereon.

4. The bicycle handlebar assembly as claimed in claim 1, wherein the handlebar and stem are made from carbon fibers.

5. The bicycle handlebar assembly as claimed in claim 1, wherein the stem has a through hole vertically defined at the end opposite to the connection end and a gap vertically defined at the end opposite to the connection end and in communication with the through hole of the stem.
